(19) United States
(12) Patent Application Publication
(10) Pub. No.: US 2020/0298594 A1
(43) Pub. Date: Sep. 24, 2020

(54) INSTALLATION FOR PRINTING AND DIE-CUTTING LAMINAR BODIES

(71) Applicant: Comercial Industrial Maquinaria Carton Ondulado S.L., Barcelona (ES)

(72) Inventors: Ramon SERRA OBIOL, Barcelona (ES); Jordi Puig Vargas, Barcelona (ES)

(73) Assignee: Comercial Industrial Maquinaria Carton Ondulado, S.L., Barcelona (ES)

(21) Appl. No.: 16/817,672

(22) Filed: Mar. 13, 2020

(30) Foreign Application Priority Data
Mar. 18, 2019 (ES) U201930439

(51) Int. Cl. B41J 11/66

(52) U.S. Cl. CPC B41J 11/66

(57) ABSTRACT

The invention relates to an installation for printing and die-cutting laminar bodies, which comprises a digital printing station (1) for printing at least one face of the laminar bodies, and a die-cutting station (2) for die-cutting the laminar bodies coming from the digital printing station (1), comprising first conveying means (3) for moving the laminar bodies (P) positioned between the digital printing station (1) and a redirection station (5), and second conveying means (4) for moving the laminar bodies between the outlet of the redirection station (5) and the die-cutting station (2), The digital printing station defines an axial direction of travel and the die-cutting station (2) defines an axial direction of travel that is perpendicular to the axial direction of travel of the laminar bodies in the digital printing station (1), such that an L-shaped path of the laminar bodies (P), viewed in the plan view, is defined.

### RELATED APPLICATIONS

This application claims the benefit of priority of Spanish Patent Application No. U201930439 filed on Mar. 18, 2019, the contents of which are incorporated herein by reference in their entirety.

### FIELD AND BACKGROUND OF THE INVENTION

The object of this application is to provide an installation for printing and die-cutting laminar bodies, the essential features of which are defined in claim 1.

More specifically, the invention proposes the development of an installation for printing and die-cutting laminar bodies, comprising a digital printing station for printing at least one face of the laminar bodies, and a die-cutting station for die-cutting the laminar bodies coming from the digital printing station, such that the installation takes a general “L” shape by arranging the printing station perpendicular to the die-cutting station.

In a conventional flexographic printing line with a die-cutting station for laminar bodies, such as sheets of cardboard for constructing boxes, the diameter used in the die-cutting cylinder that forms part of the die-cutting station coincides with a printing cylinder that is part of a flexographic printing station, such that for each rotation completed by the cylinder, a template corresponding to one cardboard box is printed and die cut.

Digital printing is currently gaining increasing importance, thereby substituting flexographic printing. On a line based on digital printing, a die-cutting station cannot be installed in line mainly due to two reasons.

One of these reasons is the fact that in digital printing, the distance between plates (laminar bodies) is minimal and remains constant, so the distance between the start of two consecutive plates (laminar bodies) can vary, since it depends on the length of each plate. Therefore, it is not possible to use a die-cutting cylinder because it has a particular development distance. A second reason is the fact that if it were possible to separate the plates in order to obtain a constant distance between the start of one plate and the start of the next plate to allow the use of a die-cutting cylinder, the development distance of the die-cutting cylinder must be at least the corresponding length of the largest plate to be printed. Currently, plate lengths may be up to 3 metres long, so the diameter of the die-cutting cylinder in that case would have to be approximately one metre. This diameter is much larger than the recommended value because it results in more difficult handling of the dies, for example, to install them in and remove them from the die-cutting station, and to store them.

In addition, the applicant is unaware of any invention at present that incorporates all of the features that are described in this specification.

### SUMMARY OF THE INVENTION

The present invention has been developed in order to provide an installation for printing and die-cutting laminar bodies which is a novelty within the field of application and solves the above-mentioned drawbacks, also providing other additional advantages that will be evident from the accompanying description below.

Therefore, an object of the present invention is to provide an installation for printing and die-cutting laminar bodies, which comprises a digital printing station for printing at least one face of the laminar bodies, and a die-cutting station for die-cutting the laminar bodies coming from the digital printing station, comprising first conveying means for moving the laminar bodies positioned between the digital printing station and a redirection station, and second conveying means for moving the laminar bodies between the outlet of the redirection station and the die-cutting station. Specifically, the invention is characterised in that the digital printing station defines an axial direction of travel and the die-cutting station defines an axial direction of travel that is perpendicular to the axial direction of travel of the digital printing, such that an L-shaped path of the laminar bodies, viewed in the plan view, is defined.

Thanks to these features, and due to the fact that in the axial direction of the laminar bodies in the digital printing station the maximum length of the laminar bodies or plates is longer than its maximum width, it is possible to use a die-cutting cylinder with a diameter that is not complicated to handle, which facilitates the operations of installing and removing the die-cutting cylinder.

According to another aspect of the invention, the redirection station comprises a receiving area for the laminar bodies which has a horizontal support surface on which the laminar bodies can be stacked, and is supported on a movable base plate that can move linearly on at least one coordinate axis by means of guiding means, and end-stop elements that are positioned in portions of the perimeter of the support surface. In addition, it includes an insertion device that has a system of multiple rotating endless belts, equipped with a suction system.

Preferably, the first conveying means comprise a plurality of endless belts arranged parallel to each other with the capacity to be extended telescopically, with one end of the endless belts associated with the output area of the digital printing station and the opposite end associated with the intake area of the redirection station. Advantageously, it is possible for said first conveying means to move in a direction perpendicular to the axial direction of travel of the digital printing station by means of guiding means.

In a preferred embodiment, the seconds conveying means comprise a plurality of endless belts arranged parallel to each other with the capacity to be extended telescopically, with one end of the endless belts associated with the output area of the insertion device of the redirection station and the opposite end associated with the die-cutting station.

Also preferably, the guiding means on which the base plate can be moved, as well as the first conveying means comprise rails that can be fixed to the floor.

Advantageously, the first conveying means include a movable base plate in one direction of travel of the laminar bodies coming from the digital printing station. This base plate can be mounted on the above-mentioned guiding means.

The described installation therefore represents an innovative structure with structural and constituent characteristics that are heretofore unknown, reasons which, taken together with its usefulness, provide it with sufficient grounds for obtaining the requested exclusivity privilege.

Other features and advantages of the installation for printing and die-cutting laminar bodies object of the present invention will be evident from the description of a preferred but not exclusive embodiment, which is illustrated to provide a non-limiting example in the attached drawings, in which:

### BRIEF DESCRIPTION OF THE SEVERAL VIEWS OF THE DRAWINGS

FIG. 1 shows a perspective view of an embodiment of the installation according to the present invention;

FIG. 2 shows a plan view of the installation shown in the previous figure;

FIG. 3 shows a plan view of the installation shown in FIG. 1, manipulating laminar bodies with dimensions larger than those of the laminar bodies shown in FIG. 2.

### DESCRIPTION OF SPECIFIC EMBODIMENTS OF THE INVENTION

The aforementioned figures, according to the adopted numbering, show a preferred embodiment of the invention, which comprises the parts and elements indicated and described in detail below.

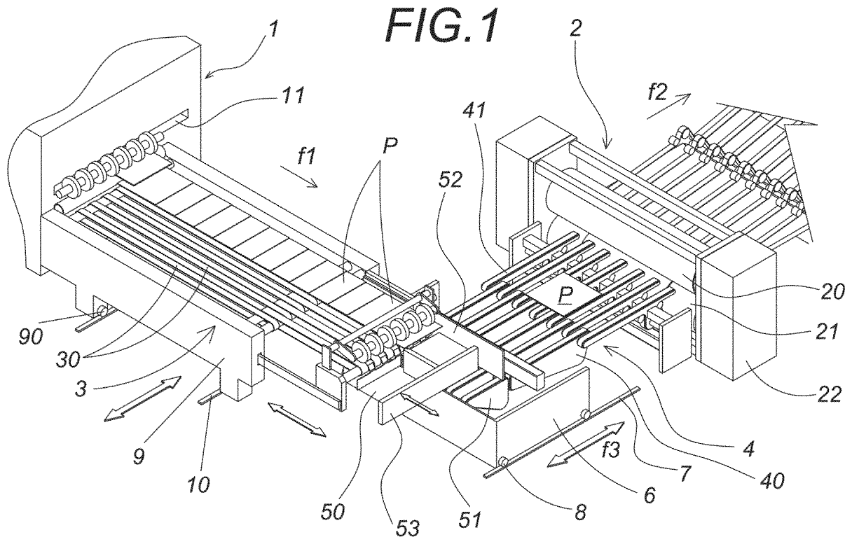

A preferred embodiment of the installation for printing and die cutting for the handling of laminar bodies (P), shown schematically in FIG. 1, in general comprises a digital printing station (1) intended to print at least one face of the laminar bodies (P), being of a known type that is commercially available on the market, so it will not be described in greater detail.

In addition, the installation comprises a die-cutting station (2), also of a known type that is commercially available on the market, intended for the die-cutting of the laminar bodies (P) coming from the digital printing station, which essentially consists of a die-holding cylinder (21) facing a counter-die cylinder (20) between which the laminar body (P) travels, mounted on a base plate (22).

In FIG. 1, the arrows (f) indicate the direction of travel of the laminar bodies (P).

In addition, the installation comprises first motorised conveying means (3) to move the laminar bodies that are discharged through an opening (11) in the digital printing station (1) and second motorised conveying means (4) to move the laminar bodies (P) located before the die-cutting station (2), which will be explained in greater detail below.

The installation adopts a general L-shaped arrangement, such that the digital printing station (1) defines an axial direction of travel (f 1) of the laminar bodies (P) and the die-cutting station (2) defines an axial direction of travel (f2) of the laminar bodies

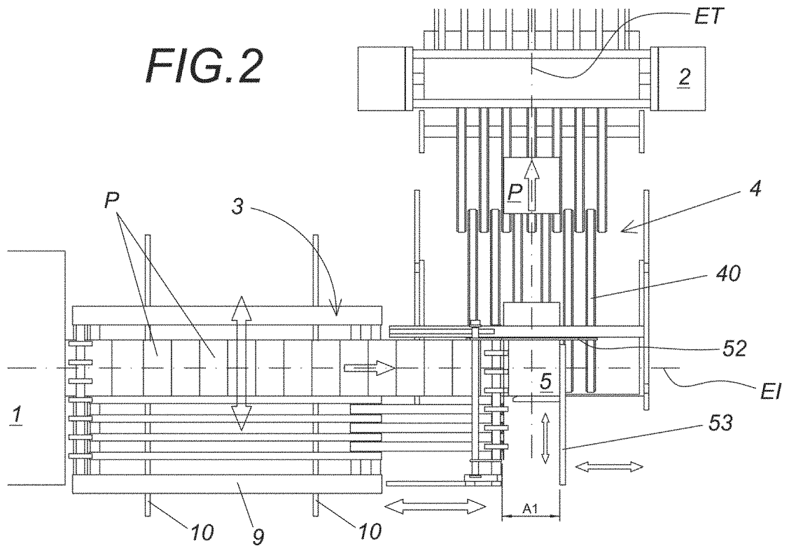

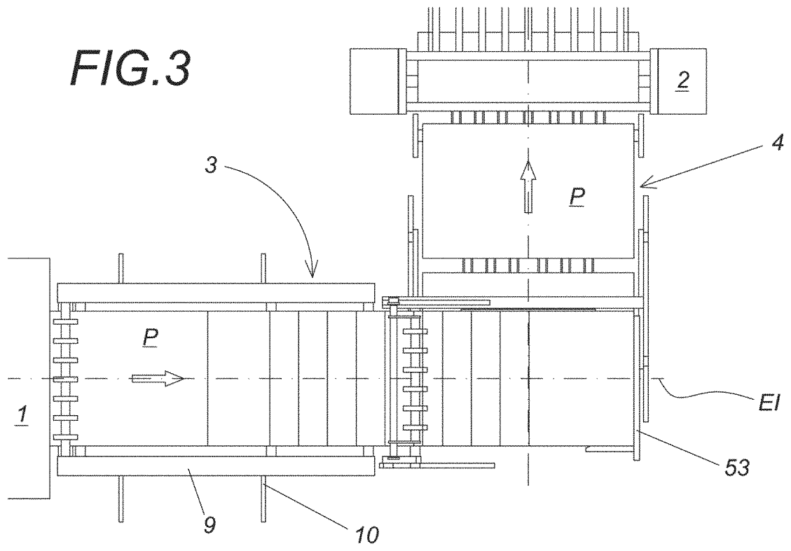

(P) that is perpendicular with respect to the axial direction of travel of the digital printing station (1), including a redirection station (5) for the laminar bodies (P) with an intake area and an output area arranged in such a way as to define a path of travel for the laminar bodies that is L-shaped seen from the plan view, which is clearly shown in FIGS. 2 and 3. In other words, an axis (EI) related to the digital printing station (1) is perpendicular to an axis (ET) associated with the die-cutting station (2) (see FIGS. 2 and 3).

Going into greater detail on the redirection station (5), it comprises a receiving area (50) for the laminar bodies (P) which has a horizontal support surface on which the laminar bodies are deposited, one on top of another to form a pile, an expulsion area (51) equipped with belts with a suction system. As shown in FIG. 1, the redirection station (5) also includes end-stop elements that are positioned in portions of the perimeter of the support surface, which in general consist of a series of platens. Therefore, the end-stop elements are fitted with a front stop platen (52) solidly fixed to the base plate that comes into contact with a side of the laminar element (P) that exits the digital printing station (1), regardless of the size of the laminar element, as well as a movable stop platen (53) that is arranged perpendicularly to the fixed front stop platen (52)

All of these elements are supported by a movable base plate (6) capable of moving in a direction perpendicular to the axial direction of travel (f1) of operation of the digital printing station (1) by means of guiding means. These guiding means on which the base plate (6) can move comprise a pair of rails (7) fixed to the surface of the floor, through which roller means (8) (shown schematically in the drawings) can slide in the direction indicated by the arrow (f3).

Now making specific reference to the first conveying means (3), they comprise a plurality of endless belts (30) arranged parallel to each other with the capacity to be extended telescopically and driven by a motor in a known manner, with one end of the endless belts (30) associated with the output area of the digital printing station (1) and the opposite end associated with the intake area of the redirection station (5). These first conveying means (3) are supported on a movable base plate (9) that, with the help of guiding means, is capable of moving in a direction perpendicular to the axial direction of travel of the laminar bodies (P) in the digital printing station (1). The movement of the movable base plate (9) is provided by the arrangement of rails (10) and roller members (90) located in the lower part of the movable base plate (9).

With respect to the second conveying means (4), they comprise a plurality of endless belts (41) arranged parallel to each other with the capacity to be extended telescopically (by conventional means), with one end of the endless belts associated with the output area of the insertion device (40) of the redirection station (5) and the opposite end associated with the die-cutting station (2) on which the laminar bodies (P) travel horizontally.

All of the movements described above carried out by the guide systems located in the installation allow the geometric centre of the stack formed by laminar bodies in the redirection station (5) to coincide with the intersection of the axes (EI) and (ET).

The details, shapes, dimensions and other accessory elements used in the manufacture of the installation of the invention may be conveniently substituted with others that do not fall outside the scope defined by the claims included below.

What is claimed is:

1. An installation for printing and die-cutting laminar bodies, which comprises a digital printing station (1) for printing at least one face of the laminar bodies, and a die-cutting station (2) for die-cutting the laminar bodies coming from the digital printing station (1), comprising first conveying means (3) for moving the laminar bodies (P) positioned between the digital printing station (1) and a redirection station (5), and second conveying means (4) for moving the laminar bodies positioned between the outlet of the redirection station (5) and the die-cutting station (2), characterised in that the digital printing station defines an axial direction of travel and the die-cutting station (2) defines an axial direction of travel that is perpendicular to the axial direction of travel of the laminar bodies in the digital printing station (1), such that an L-shaped path of the laminar bodies (P), viewed in the plan view, is defined.

2. The installation for printing and die-cutting laminar bodies according to claim 1, characterised in that the redirection station comprises a receiving area for the laminar bodies that has a horizontal support surface on which the laminar bodies (P) can be stacked, and is supported on a movable base plate that can move linearly on at least one coordinate axis by guiding means, and end-stop means that are positioned in portions of the perimeter of the support surface, including an insertion device that has a system of multiple rotating endless belts, which incorporates a suction system.

3. The installation for printing and die-cutting laminar bodies according to claim 1, characterised in that the first conveying means comprise a plurality of endless belts arranged parallel to each other with the capacity to be extended telescopically, with one end of the endless belts associated with the output area of the digital printing station and the opposite end associated with the intake area of the redirection station.

4. The installation for printing and die-cutting laminar bodies according to claim 1, characterised in that the seconds conveying means comprise a plurality of endless belts arranged parallel to each other with the capacity to be extended telescopically, with one end of the endless belts associated with the output area of the insertion device of the redirection station and the opposite end associated with the die-cutting station.

5. The installation for printing and die-cutting laminar bodies according to claim 2, characterised in that the guiding means on which the base plate can be moved comprise rails that can be fixed to the floor.

6. The installation for printing and die-cutting laminar bodies according to claim 1, characterised in that the first conveying means include a movable base plate in one direction of travel of the laminar elements coming from the digital printing station.
